(19) United States
(12) Patent Application Publication
(10) Pub. No.: US 2023/0217365 A1
(43) Pub. Date: Jul. 6, 2023

(54) WIRELESS NETWORK AND METHOD TO HANDLE REJECTED NSSAI AREA IN WIRELESS NETWORK

(71) Applicant: SAMSUNG ELECTRONICS CO., LTD., Suwon-si (KR)

(72) Inventors: Lalith KUMAR, Bangalore (IN); Koustav ROY, Bangalore (IN); Arijit SEN, Bangalore (IN); Danish Ehsan HASHMI, Bangalore (IN); Mahmoud WATFA, Bangalore (IN)

(21) Appl. No.: 18/150,069

(22) Filed: Jan. 4, 2023

(30) Foreign Application Priority Data
Jan. 6, 2022 (IN) 202241000731
Dec. 23, 2022 (IN) 202241000731

(51) Int. Cl. H04W 48/18; H04W 60/04

(52) U.S. Cl. CPC H04W 48/18; H04W 60/04

(57) ABSTRACT

The disclosure relates to a 5G or 6G communication system for supporting a higher data transmission rate and to a method to handle rejected NSSAI area. The method includes receiving a NAS message indicating registration accept or registration reject with a reject cause. The reject cause indicating a S-NSSAI is not available in a subset of a current registration area where the reject cause is applied for a S-NSSAI. In an example, the method includes storing the rejected S-NSSAI in a rejected NSSAI for the subset of the current registration area. In another example, the method includes deleting a current registration area based on the subset of the current registration area where the reject cause is applied for the S-NSSAI. The UE considers a S-NSSAI part of the requested NSSAI as not applicable to current tracking area and S-NSSAI part of the requested NSSAI is allowed outside current tracking area.

### CROSS-REFERENCE TO RELATED APPLICATIONS

This application is based on and claims priority under 35 U.S.C. § 119 to Indian Provisional Patent Application No. 202241000731, filed Jan. 6, 2022, and Indian Non-Provisional Patent Application No. 202241000731 filed Dec. 23, 2022, in the Indian Patent Office, the disclosure of which are incorporated by reference herein in their entirety.

### BACKGROUND

### 1. Field

The present disclosure relates to wireless communication, and more specifically related to a wireless network and a method to apply rejected Network Slice Selection Assistance Information (NSSAI) area in the wireless network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The principal object of the embodiments herein is to provide a wireless network and a method to apply rejected/not allowed/not supported Network Slice Selection Assistance Information (NSSAI) area in the wireless network.

Accordingly, embodiments herein disclose a method to handle rejected Network Slice Selection Assistance Information (NSSAI) area in a wireless network. The method includes sending, by a User Equipment (UE) in the wireless network, a registration request message with a requested NSSAI to a network apparatus in the wireless network. Further, the method includes receiving, by the UE, a Non-access stratum (NAS) message indicating at least one of a registration accept or registration reject with a reject cause from the network apparatus and a subset of a current registration area where the S-NSSAI is not allowed or allowed. The reject cause indicates a Single Network Slice Selection Assistance Information (S-NSSAI) is not available in a subset of a current registration area where the reject cause is applied for a Single Network Slice Selection Assistance Information (S-NSSAI). In an embodiment, the method includes storing the rejected S-NSSAI in a rejected NSSAI for the subset of the current registration area and a subset of a current registration area where the S-NSSAI is not allowed or allowed. In another embodiment, the method includes deleting the current stored registration area, consider the S-NSSAI is not available for the current tracking area. In an embodiment, the method includes determining whether a S-NSSAI is allowed in the current area (for e.g., whenever a new area is entered) based on the stored information and triggering at least one of the registration procedure with requested NSSAI including the S-NSSAI or Protocol Data Unit (PDU) session associated with S-NSSAI to receive the services associated with S-NSSAI based on determination that S-NSSAI is allowed in the current area.

In an embodiment, the method includes determining, by the UE, whether the S-NSSAI is allowed outside the current tracking area. Further, the method includes triggering, by the UE, a registration procedure with the requested NSSAI to receive services associated with the S-NSSIA as part of the requested NSSAI based on the determination that the requested S-NSSAI is allowed outside the current tracking area (i.e., current tracking area in this context is the tracking area where reject cause/indication is received indicating S-NSSAI is not allowed/not supported/rejected) and thus when the UE is moving out of that current tracking area that respective S-NSSAI will be allowed.

In an embodiment, the UE stores the S-NSSAI in the rejected NSSAI for the subset of the current registration area until at least one of switching off the UE, the UE moving out of the current registration area, a Universal Integrated Circuit Card (UICC) containing a Universal Subscriber Identity Module (USIM) in the UE is removed, an entry of a “list of subscriber data” with a Standalone Non-Public Networks (SNPN) identity of a current SNPN is updated, and a rejected list is removed or deleted.

In an embodiment, the method includes applying, by the UE, the NSSAI in the current registration area other than the subset of the current registration area.

In an embodiment, the reject cause is applied for the S-NSSAI received by the UE along with the registration reject message or a configuration update command message or in the NAS message for the subset of the current registration area.

In an embodiment, the subset of the current registration area or the term area includes at least one of Tracking Area identity (TAI)-ID(s), cell ID(s), area identified by geographical co-ordinates, and Closed Access Group (CAG) ID(s).

Accordingly, embodiments herein disclose a method to apply rejected NSSAI area in a wireless network. The method includes receiving, by a network apparatus in the wireless network, a registration request message for a candidate Tracking Area identity (TAI) from the plurality of TAIs from a User Equipment (UE) in the wireless network. Further, the method includes sending, by the network apparatus, a Non-access stratum (NAS) message indicating a registration reject or a registration accept to the UE with a reject cause (that is, the reject cause has to be treated as an indication in this embodiment) to the UE. The reject cause indicates a Single Network Slice Selection Assistance Information (S-NSSAI) is not available in the current registration area, and a subset of the current registration area where the reject cause is applied for the S-NSSAI. The UE applies the NSSAI in the current registration area other than the subset of the current registration area.

Accordingly, embodiments herein disclose a UE to apply rejected NSSAI area in a wireless network. The UE includes a rejected NSSAI area controller communicatively coupled to a memory and a processor. The rejected NSSAI area controller is configured to send a registration request message with a requested NSSAI to a network apparatus in the wireless network. Further, the rejected NSSAI area controller is configured to receive a NAS message indicating at least one of a registration accept or registration reject with a reject cause from the network apparatus. The reject cause indicating a S-NSSAI is not available in a subset of a current registration area where the reject cause is applied for a Single Network Slice Selection Assistance Information (S-NSSAI) and a subset of a current registration area where the S-NSSAI is not allowed or allowed. In an embodiment, the rejected NSSAI area controller is configured to store the rejected S-NSSAI in a rejected NSSAI for the subset of the current registration area. In another embodiment, the rejected NSSAI area controller is configured to delete the current stored registration area, consider the S-NSSAI is not available for the current tracking area by adding the respective tracking area to rejected NSSAI area list. In another embodiment, the rejected NSSAI area controller is configured to determine whether a S-NSSAI is allowed in the current area based on the stored information and triggering at least one of the registration procedure with requested NSSAI including the S-NSSAI or Protocol Data Unit (PDU) session associated with S-NSSAI to receive the services associated with S-NSSAI based on determination that S-NSSAI is allowed in the current area.

Accordingly, embodiments herein disclose a network apparatus to handle rejected NSSAI area in a wireless network. The network apparatus includes a rejected NSSAI area controller communicatively coupled to a memory and a processor. The rejected NSSAI area controller is configured to receive a registration request message for a candidate Tracking Area identity (TAI) from the plurality of TAIs from a User Equipment (UE) in the wireless network. Further, the rejected NSSAI area controller is configured to send a NAS message indicating a registration reject or a registration accept to the UE with a reject cause to the UE. The reject cause indicates a Single-Network Slice Selection Assistance Information (S-NSSAI) is not available in the current registration area, and a subset of the current registration area where the reject cause is applied (i.e., allowed/supported or not allowed/not supported/rejected) for the S-NSSAI. The UE applies(i.e., allowed/supported or not allowed/not supported/rejected) the NSSAI in the current registration area other than the subset of the current registration area (if for the subset of the current registration area the S-NSSAI is not supported).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The method and the wireless network are illustrated in the accompanying drawings, throughout which like reference letters indicate corresponding parts in the various figures. The embodiments herein will be better understood from the following description with reference to the drawings, in which:

FIG. 1 is an example sequence diagram illustrating drawbacks when NSSAI rejected in wrong a TAI list, according to a prior art;

FIG. 2 is a sequence diagram illustrating a method for deleting a current registration area upon reject cause #62, according to an embodiment as disclosed herein;

FIG. 3 is a sequence diagram illustrating a method for marking NSSAI rejected only for respective tracking area, according to an embodiment as disclosed herein;

FIG. 4 is a sequence diagram illustrating a method for adding TAI list along with Registration reject or any NAS message, according to an embodiment as disclosed herein;

FIG. 5 is a sequence diagram illustrating a method for deleting S-NSSAI or Rejected NSSAI when it receives a CUC message, according to an embodiment as disclosed herein;

FIG. 6 illustratesvarious hardware components of a UE, according to the embodiments as disclosed herein;

FIG. 7 illustrates various hardware components of a network apparatus (e.g., AMF entity), according to the embodiments as disclosed herein;

FIG. 8 is a flow chart illustrating a method, implemented by the UE, to handle a rejected NSSAI area in a wireless network, according to the embodiments as disclosed herein; and

FIG. 9 is a flow chart illustrating a method, implemented by the network apparatus, to handle the rejected NSSAI area in the wireless network, according to the embodiments as disclosed herein.

### DETAILED DESCRIPTION

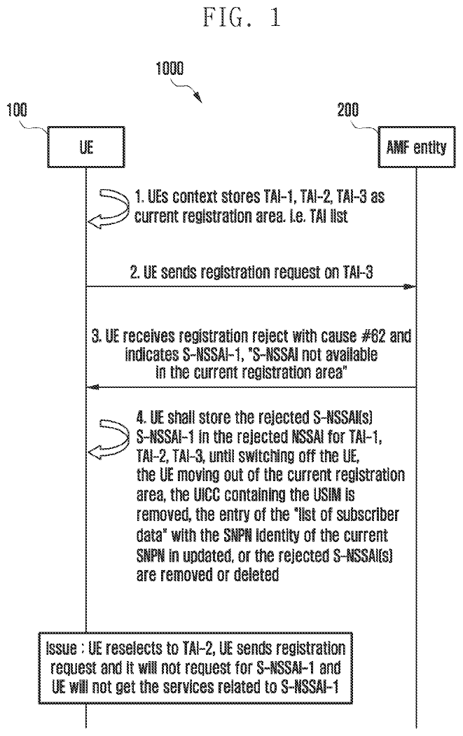

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The present method/system has several drawbacks when a User Equipment (UE) (100) gets a rejected Single Network Slice Selection Assistance Information (S-NSSAI) from a network entity (e.g., AMF entity (200)). FIG. 1 is an example sequence diagram illustrating drawbacks when NSSAI rejected is maintained for whole TAI list. At step-1, the UEs context stores TAI-1, TAI-2, and TAI-3 (i.e., TAI list) as a current registration area. At step-2, the UE (100) sends a registration request on the TAI-3 to the AMF entity (200). At step-3, the UE (100) receives a registration reject with cause #62 and indicates S-NSSAI-1, “S-NSSAI not available in the current registration area”. At step-4, the UE (100) shall store the rejected S-NSSAI(s) S-NSSAI-1 in the rejected NSSAI for TAI-1, TAI-2, TAI-3 until switching off the UE (100), the UE (100) moving out of the current registration area, a Universal Integrated Circuit Card (UICC) containing a Universal Subscriber Identity Module (USIM) is removed, the entry of the “list of subscriber data” with a Standalone Non-Public Networks (SNPN) identity of the current SNPN is updated, or the rejected S-NSSAI(s) are removed or deleted. The whole of registration area (e.g., TAI-1, TAI-2, TAI-3), the UE (100) may not support S-NSSAI-1, but it is possible that S-NSSAI-1 may be its supported in the subset of the registration area. This aspect was not considered in the prior art. At step-5, as drawbacks, the UE (100) reselects to TAI-2, UE (100) sends registration request and it will not request for S-NSSAI-1 from network and the UE (100) will not get the services related to S-NSSAI-1.

Thus, it is desired to address the above-mentioned disadvantages or other shortcomings or at least provide a useful alternative.

List of Abbreviations used in the patent disclosure:

a) Access and Mobility Management Function (AMF),

b) Network Slice Selection Assistance Information (NSSAI),

c) Network Slice Selection Function (NSSF),

d) Network Slice Selection Function (NSSF),

e) Single Network Slice Selection Assistance Information (S-NSSAI),

Accordingly, embodiments herein disclose a method to handle rejected NSSAI area in a wireless network. The method includes sending, by a UE in the wireless network, a registration request message with a requested NSSAI to a network apparatus in the wireless network. Further, the method includes receiving, by the UE, a NAS message indicating at least one of registration accept or registration reject with a reject cause from the network apparatus. The reject cause indicates a S-NSSAI is not available in a subset of a current registration area where the reject cause is applied for a S-NSSAI and a subset of a current registration area where the S-NSSAI is not allowed or allowed. In an embodiment, the method includes storing the rejected S-NSSAI in a rejected NSSAI for the subset of the current registration area. In another embodiment, the method includes deleting the current stored registration area, consider the S-NSSAI is not available for the current tracking area. In another embodiment, the method includes determining whether a S-NSSAI is allowed in the current area based on the stored information and triggering at least one of the registration procedure with requested NSSAI including the S-NSSAI or Protocol Data Unit (PDU) session associated with S-NSSAI to receive the services associated with S-NSSAI based on determination that S-NSSAI is allowed in the current area

In an embodiment, the network apparatus can provide registration area i.e., TAI list (e.g., TAI-1, TAI-2, TAI-3) to the UE, also the network apparatus can explicitly indicate a subset of the registration area, in the NAS message, where a given slice is actually rejected/not available/not supported or network apparatus (e.g., AMF entity) can indicate the subset of the registration area where a given slice(i.e., S-NSSAI) is accepted/available/supported. For example, in TAI-3. With this information UE can start using the give slice in the area where the slice is allowed to be operational.

In an embodiment, when network apparatus sends the cause#62 or any other cause indicating “S-NSSAI not available in the current registration area”, the UE will delete the registration area, TAI list. Given TAI list (consisting of TAI-1,2,3) is deleted, the UE cannot consider that area applicable for rejected S-NSSAI as it does not have registration area stored. But rather currently camped TAI(TAI-3) only is applied i.e., S-NSSAI is considered as rejected/not available/not supported in TAI-3. If the UE moves out of the current TAI(TAI-3) the UE will consider the new TAI as allowed TAI for S-NSSAI-1 and it will request that to the network apparatus.

In an embodiment, the network apparatus (e.g., AMF entity or the like) provides information related to the supported or not supported TA(s) regarding a rejected S-NSSAI in a registration area (RA) to the UE in a registration procedure and a UE configuration update procedure or it can be any other NAS procedure if the UE indicates that it supports this feature. The UE shall be able to request a rejected S-NSSAI, by initiating a registration update procedure, in a supported TA based on the supported/not supported TA information associated with this S-NSSAI.

In an embodiment, the method can be used to apply rejected NSSAI area. The method includes deleting the current registration area upon rejecting cause #62 from a network entity (e.g., AMF). Further, the method includes marking NSSAI rejection only for the respective tracking area. Further, the method includes adding, by the network entity, adding TAI list along with Registration reject or any NAS message. Further, the method includes applying a rejected slice to the received TAI list when the TAI list (or current registration area) is received as part of the NAS message. Further, the method includes storing applied rejected slices when the TAI list is NOT received as part of the NAS message. Further, the method includes storing rejected S-NSSAI(s) for TAI UE is currently camping that is the one broadcasted by RAN is applied. Further, the method includes deleting S-NSSAI or Rejecting NSSAI when the UE receives a CUC message from the network entity.

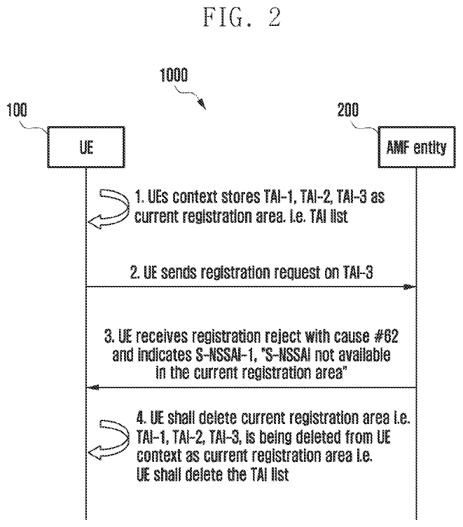

Referring now to the drawings, and more particularly to FIGS. 2 through 9, there are shown preferred embodiments.

FIG. 2 is a sequence diagram illustrating a method for deleting the current registration area upon reject cause #62, according to an embodiment as disclosed herein.

At step-1, the UEs context stores TAI-1, TAI-2, and TAI-3 (i.e., TAI list) as the current registration area. At step-2, the UE (100) sends a registration request on TAI-3 to the AMF entity (200). At step-3, the UE (100) receives registration reject with cause #62 and indicates S-NSSAI-1, “S-NSSAI not available in the current registration area”. At step-4, the UE (100) shall delete current registration area (i.e., TAI list) i.e., TAI-1, TAI-2, TAI-3 is being deleted from UE context as the current registration area. Given, the current stored registration area is deleted UE will be left with only current track area i.e., TAI-3, the UE will consider S-NSSA-1 as rejected/not available/not supported in TAI-3 by adding into the appropriate list UE can track of this information, the UE will not request for S-NSSAI-1 in the TAI-3 area. The UE will request for S-NSSAI-1 when the UE moves of current tracking area i.e., TAI-3.

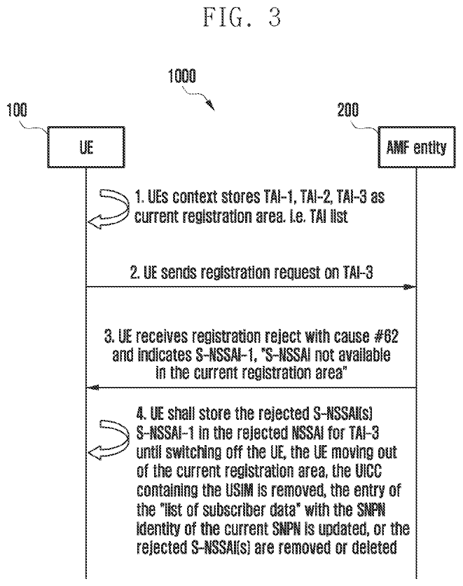

FIG. 3 is a sequence diagram illustrating a method for marking NSSAI rejected only for respective tracking area, according to an embodiment as disclosed herein.

At step-1, UEs context stores TAI-1, TAI-2, and TAI-3 as the current registration area. At step-2, the UE (100) sends a registration request on TAI-3 to the AMF entity (200). At step-3, the UE (100) receives registration reject with cause #62 and indicates S-NSSAI-1, “S-NSSAI not available in the current registration area”. At step-4, the UE (100) shall store the rejected S-NSSAI(s) S-NSSAI-1 in the rejected NSSAI for TAI-3, i.e. it will not store rejected S-NSSAI(s) S-NSSAI-1 for TAI-2 and TAI-1, until switching off the UE (100), the UE (100) moving out of the current registration area or until UE (100) is moving out of the TAI3, the UICC containing the USIM is removed, the entry of the “list of subscriber data” with the SNPN identity of the current SNPN is updated, or the rejected S-NSSAI(s) are removed or deleted.

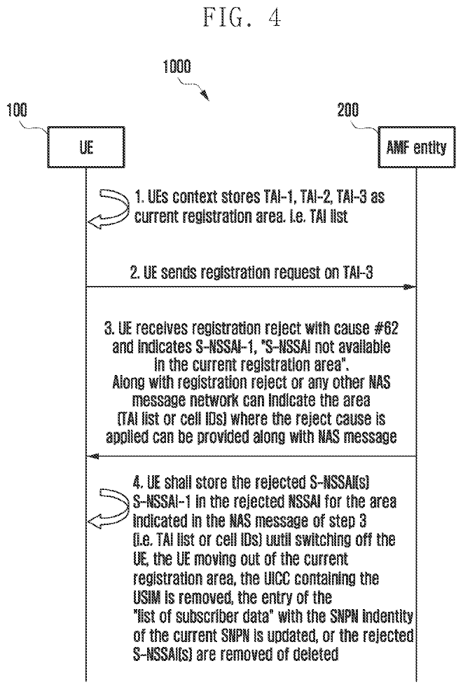

FIG. 4 is a sequence diagram illustrating a method for adding TAI list along with Registration reject or any NAS message, according to an embodiment as disclosed herein.

At step-1, UEs context stores TAI-1, TAI-2, and TAI-3 as the current registration area. At step-2, the UE (100) sends a registration request on TAI-3 to the AMF entity (200). At step-3, the UE (100) receives registration reject with cause #62/any other indication and indicates S-NSSAI-1, “S-NSSAI not available in the current registration area”(It can be with any name/indication). Along with registration reject or any other NAS message network can indicate the area (TAI list or cell IDs) where the reject cause is applied for the given S-NSSAI(s) can be provided along with the Non access stratum(NAS) message. i.e., the area where the S-NSSAI is not supported/rejected/not available or supported/available is indicated to the UE using a NAS message optionally within the registration area. At step-4, the UE (100) shall store the rejected S-NSSAI(s) S-NSSAI-1 in the rejected NSSAI for the area (TAI list or cell IDs) received in step 3, until switching off the UE (100), the UE (100) moving out of the current registration area, the UICC containing the USIM is removed, the entry of the “list of subscriber data” with the SNPN identity of the current SNPN is updated, or the rejected S-NSSAI(s) are removed or deleted.

In another embodiment, if the TAI list (or current registration area) is received as part of the NAS message along with the reject cause#62, then rejected slice is applied to the received TAI list (in general the area received). If the TAI list (or current registration area or in general the area which is in terms of TAIs and Cell IDs or geographical co-ordinates) is NOT received as part of the NAS message, then one stored in the UE (100) is applied. The UE (100) receives registration reject with cause #62 and indicates S-NSSAI-1, “S-NSSAI not available in the current registration area”. The UE (100) shall store the rejected S-NSSAI(s) for TAI UE is currently camping that is the one broadcasted by RAN is applied.

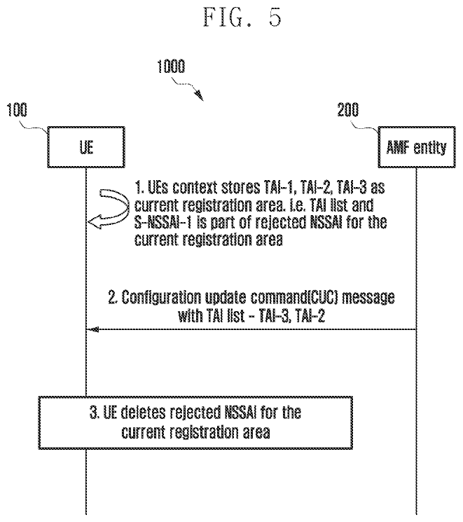

FIG. 5 is a sequence diagram illustrating a method for deleting S-NSSAI or Rejected NSSAI when it receives the CUC message, according to an embodiment as disclosed herein.

At step-1, UEs context stores TAI-1, TAI-2, and TAI-3 as the current registration area (i.e., the TAI list and S-NSSAI-1 are part of rejected NSSAI for the current registration area). At step-2, the UE (100) receives Configuration update command (CUC) message with TAI list—TAI-3, TAI-2. At step-3, the UE (100) deletes rejected NSSAI for the current registration area it receives the CUC message.

When configuration update command message is received with new TAI list (i.e., the UE (100) shall delete the rejected NSSAI for the current registration area).

In yet another embodiment, only if there is a change in the TAI list when compared to the TAI list stored in the UE (100), the UE (100) shall delete the rejected NSSAI for the current registration area.

In yet another embodiment if the UE (100) receives the TAI list in the configuration update command message, the UE (100) shall delete the rejected NSSAI for the current registration area stored in the UE (100).

In yet another embodiment, the UE (100) can compare the previously stored registration area and newly received registration area for e.g., TAI-1, TAI-2, TAI-3 was stored and marked as rejected for a S-NSSAI and now the UE (100) receives new registration area for e.g., TAI-3, TAI-4. Then, the UE (100) shall continue to consider TAI-3 as an area where S-NSSAI is not allowed/not supported/rejected but for TAI-4 the UE (100) will consider that S-NSSAI is allowed/supported.

In this embodiment, the terms S-NSSAI is not allowed, not available, not supported and rejected are used interchangeably and have the same meaning.

In this embodiment the terms allowed, available, supported are used interchangeably and have the same meaning.

In this embodiment when the UE (100) determines that a S-NSSAI is allowed/supported/not rejected/available in the area based on embodiments discussed in the proposed method, the UE (100) can trigger at least one of the registration procedure with requested NSSAI including the S-NSSAI or PDU session associated with S-NSSAI to receive the services associated with S-NSSAI based on determination that S-NSSAI is allowed in the area and the UE (100) needs/prefers to use the services associated with S-NSSAI.

In an embodiment, when the UE (100) determines that a S-NSSAI is not allowed/not supported/rejected for the area based on embodiments discussed in the proposed methods, the UE (100) will not include the S-NSSAI in requested NSSAI when registration procedure is triggered or the UE (100) will not trigger PDU session associated with S-NSSAI to receive the services associated with S-NSSAI based on determination that S-NSSAI is not allowed/not supported/not available/rejected in the area.

In this embodiment, the UE (100) stores rejected S-NSSAI(s) S-NSSAI-1 in the rejected NSSAI for the area implies UE will track the area in which S-NSSAI is not allowed, not available, not supported or rejected or in other words UE will track S-NSSAI allowed/available/supported area. Thus, when the corresponding rejected NSSAI for the area(e.g., registration area or subset of registration area) is deleted that area becomes allowed/supported/available for that S-NSSAI to the UE.

In this embodiment, the UE (100) determines that a given S-NSSAI is allowed or not allowed in an area based on the stored information, the UE (100) can perform this determination each time it enters a new area. For e.g., if UE's stored information indicates TAI-1 is not allowed when the UE (100) is in TAI-1 it will consider TAI-1 as not allowed but when the UE (100) moves out of TAI-1 for e.g., when it enters TAI-2 it will evaluate based on its stored information whether TAI-2 is allowed area for the S-NSSAI and take actions as described in this embodiment.

In this embodiment, the steps(or illustrations) are explained with respect to rejected NSSAI for the current registration area but it is equally applicable to other reject causes listed below:
a. “S-NSSAI not available in the current PLMN or SNPN” i.e. rejected NSSAI for the current PLMN or SNPN.
b. “S-NSSAI not available in the current registration area” i.e. the rejected NSSAI for the current registration area.
c. “S-NSSAI not available due to the failed or revoked network slice-specific authentication and authorization” i.e. rejected NSSAI for the failed or revoked NSSAA.
d. “S-NSSAI not available due to maximum number of UEs reached” i.e. rejected NSSAI for the maximum number of UEs reached.
e. Single-Network Slice Selection Assistance Information (S-NSSAI) is not available in a subset of a current registration area
f. Or it can be any new reject cause or an indication
g. Rejected slices in this embodiment are for given access.

In the embodiment, the term reject cause implies an indication to the UE (100) which can be in any form like reject cause, new information element etc.

In this embodiment, illustration is provided by taking registration procedure as an example, the indication or the subset of current registration can be provided to the UE by the AMF in any of the NAS message messages like UE configuration update command message, DL NAS TRANSPORT message, registration accept, registration reject message etc. The UE actions as described in this embodiment applies.

In this embodiment the term area is used which should be treated as one of the TAIs, Cell IDs or geographical co-ordinates or any other mechanism in which physical area can be determined.

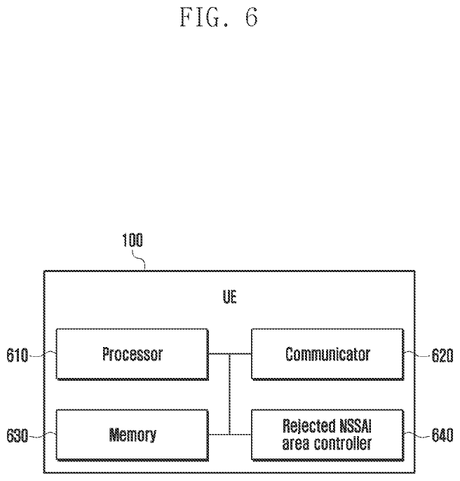

FIG. 6 illustrates various hardware components of the UE (100), according to the embodiments as disclosed herein. The UE (100) can be, for example, but not limited to a cellular phone, a smart phone, a Personal Digital Assistant (PDA), a tablet computer, a laptop computer, an Internet of Things (IoT), embedded systems, edge devices, a vehicle to everything (V2X) device or the like. In an embodiment, the UE (100) includes a processor (610), a communicator (620), a memory (630) and a rejected NSSAI area controller (640). The processor (610) is coupled with the communicator (620), the memory (630) and the rejected NSSAI area controller (640).

The rejected NSSAI area controller (640) sends the registration request message with the requested NSSAI to the network apparatus (200). Further, the rejected NSSAI area controller (640) receives the NAS message indicating at least one of the registration accept or the registration reject with the reject cause from the network apparatus (200). The reject cause indicating the S-NSSAI is not available in a subset of a current registration area where the reject cause is applied for a S-NSSAI. The illustration in this embodiment is for a single-NSSAI, but network can provide plurality of S-NSSAI(s) and indicate for each S-NSSAI what are the allowed area(e.g., TA) or not allowed area(e.g., TA) by providing respective area in the NAS message. In an embodiment, the reject cause is applied for the S-NSSAI received by the UE (100) along with the registration reject message or in the NAS message for the subset of the current registration area and the subset of the current registration area where the S-NSSAI is not allowed or allowed. The subset of the current registration area includes at least one of Tracking Area identity (TAI)-ID(s), cell ID(s), area identified by geographical co-ordinates, and Closed Access Group (CAG) ID(s).

In an embodiment, the rejected NSSAI area controller (640) stores the rejected S-NSSAI in a rejected NSSAI for the subset of the current registration area (in general area). The rejected NSSAI area controller (640) stores the S-NSSAI in the rejected NSSAI for the subset of the current registration area until at least one of switching off the UE (100), the UE (100) moving out of the current registration area, a Universal Integrated Circuit Card (UICC) containing a Universal Subscriber Identity Module (USIM) in the UE (100) is removed, an entry of a “list of subscriber data” with a Standalone Non-Public Networks (SNPN) identity of a current SNPN is updated, and a rejected list is removed or deleted.

In another embodiment, the rejected NSSAI area controller (640) deletes the current stored registration area by considering the S-NSSAI is not available for the current tracking area.

In an embodiment, the rejected NSSAI area controller (640) determines whether a S-NSSAI is allowed in the current area based on the stored information and triggers at least one of the registration procedure with requested NSSAI including the S-NSSAI or the PDU session associated with S-NSSAI to receive the services associated with S-NSSAI based on determination that S-NSSAI is allowed in the current area.

In an embodiment, the rejected NSSAI area controller (640) determines whether the S-NSSAI is allowed outside the current tracking area. Further, the rejected NSSAI area controller (640) triggers a registration procedure with the S-NSSIA as part of the requested NSSAI to receive services associated with the requested NSSAI based on the determination that the requested NSSAI is allowed outside the current tracking area.

In an embodiment, the rejected NSSAI area controller (640) applies the NSSAI in the current registration area other than the subset of the current registration area.

The rejected NSSAI area controller (640) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (610) is configured to execute instructions stored in the memory (630) and to perform various processes. The communicator (620) is configured for communicating internally between internal hardware components and with external devices via one or more networks. The memory (630) also stores instructions to be executed by the processor (610). The memory (630) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (630) may, in some examples, be considered a non-transitory storage medium. The term “non-transitory” may indicate that the storage medium is not embodied in a carrier wave or a propagated signal. However, the term “non-transitory” should not be interpreted that the memory (630) is non-movable. In certain examples, a non-transitory storage medium may store data that can, over time, change (e.g., in Random Access Memory (RAM) or cache).

Although the FIG. 6 illustrates various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

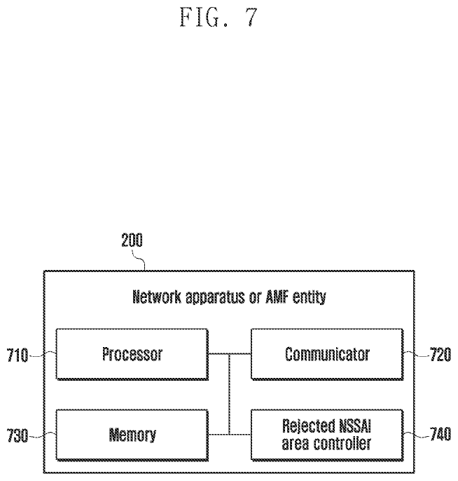

FIG. 7 illustrates various hardware components of a network apparatus (or the AMF entity) (200), according to the embodiments as disclosed herein. In an embodiment, the network apparatus (200) includes a processor (710), a communicator (720), a memory (730) and a rejected NSSAI area controller (740). The processor (710) is coupled with the communicator (720), the memory (730) and the rejected NSSAI area controller (740).

The rejected NSSAI area controller (740) receives the registration request message for the candidate TAI from the plurality of TAIs from the UE (100). Further, the rejected NSSAI area controller (740) sends the NAS message indicating the registration reject or the registration accept to the UE (100) with the reject cause to the UE (100). The reject cause indicating the S-NSSAI is not available in the current registration area, and a subset of the current registration area where the reject cause is applied for the S-NSSAI. The UE (100) applies the NSSAI in the current registration area other than the subset of the current registration area.

The rejected NSSAI area controller (740) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

Although the FIG. 7 illustrates various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

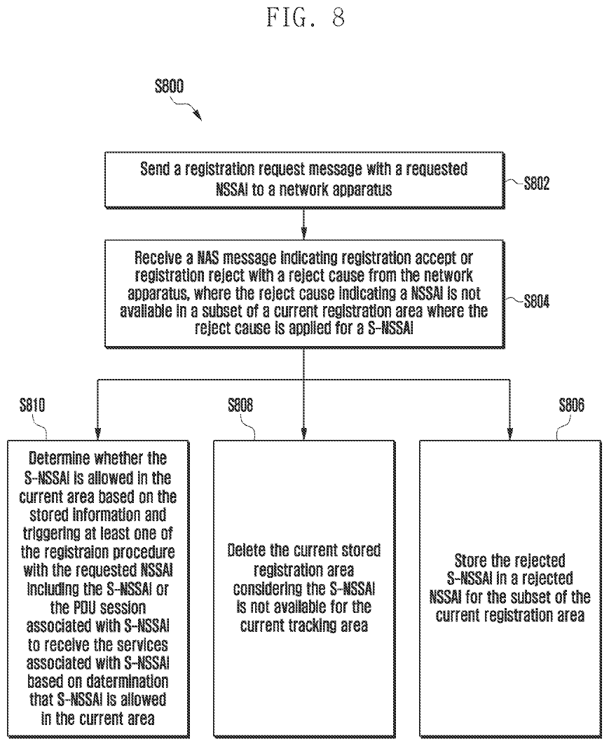

FIG. 8 is a flow chart (S800) illustrating a method, implemented by the UE (100), to handle the rejected NSSAI area in the wireless network (1000), according to the embodiments as disclosed herein. The operations (S802-S808) are handled by the rejected NSSAI area controller (640). The wireless network (1000) can be, for example, but not limited to, a fourth generation network, a fifth generation network, an open radio access network (ORAN) network or the like.

At S802, the method includes sending the registration request message with the requested NSSAI to the network apparatus (200). At S804, the method includes receiving the NAS message indicating at least one the registration accept or the registration reject with the reject cause from the network apparatus (200). The reject cause indicating the S-NSSAI is not available in a subset of a current registration area where the reject cause is applied for the S-NSSAI and a subset of a current registration area where the S-NSSAI is not allowed or allowed. At S806, the method includes storing the rejected S-NSSAI in the rejected NSSAI for the subset of the current registration area. At S808, the method includes deleting the current stored registration area, considering the S-NSSAI is not available for the current tracking area. At S810, the method includes determine whether the S-NSSAI is allowed in the current area based on the stored information and triggering at least one of the registration procedure with the requested NSSAI including the S-NSSAI or the PDU session associated with S-NSSAI to receive the services associated with S-NSSAI based on determination that S-NSSAI is allowed in the current area.

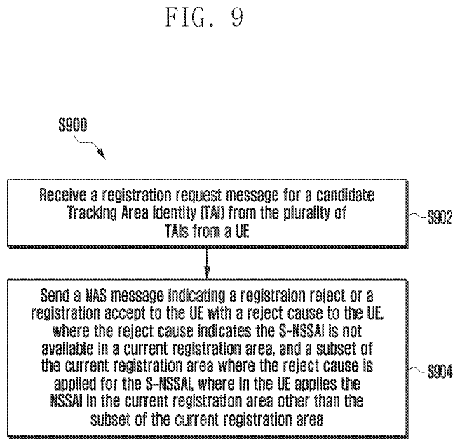

FIG. 9 is a flow chart (S900) illustrating a method, implemented by the network apparatus (200), to handle the rejected NSSAI area in the wireless network (1000), according to the embodiments as disclosed herein. The operations (S902 and S904) are handled by the rejected NSSAI area controller (740).

At S902, the method includes receiving the registration request message for the candidate TAI from the plurality of TAIs from the UE (100). At S904, the method includes sending the NAS message indicating the registration reject or the registration accept to the UE (100) with the reject cause to the UE (100). The reject cause indicating the S-NSSAI is not available in the current registration area, and a subset of the current registration area where the reject cause is applied for the S-NSSAI. The UE (100) applies the NSSAI in the current registration area other than the subset of the current registration area.

The various actions, acts, blocks, steps, or the like in the flow charts (S800 and S900) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method to handle rejected network slice selection assistance information (NSSAI) area in a wireless network, comprising:
sending, by a user equipment (UE) in the wireless network, a registration request message with a requested NSSAI to a network apparatus in the wireless network;
receiving, by the UE, a non-access stratum (NAS) message indicating at least one of:
registration accept or registration reject with a reject cause from the network apparatus, wherein the reject cause indicates a single-NSSAI (S-NSSAI) is not available in a subset of a current registration area where the reject cause is applied for a Single Network Slice Selection Assistance Information (S-NSSAI), and a subset of a current registration area where the S-NSSAI is not allowed or allowed; and
performing, by the UE, at least one of:
storing the rejected S-NSSAI in a rejected NSSAI for the subset of the current registration area;
deleting a current stored registration area, considering the S-NSSAI is not available for the current tracking area; and
determining whether a S-NSSAI is allowed in the current area based on the stored information and triggering at least one of a registration procedure with requested NSSAI including the S-NSSAI or PDU session associated with S-NSSAI to receive services associated with S-NSSAI based on determination that S-NSSAI is allowed in the current area.

2. The method as claimed in claim 1, comprising:
determining, by the UE, whether a S-NSSAI is allowed outside the current tracking area; and
triggering, by the UE, a registration procedure with the S-NSSIA as part of requested NSSAI to receive services associated with the S-NSSAI based on the determination that the S-NSSAI is allowed outside the current tracking area.

3. The method as claimed in claim 1, wherein the UE stores the S-NSSAI in the rejected NSSAI for the subset of the current registration area until at least one of switching off the UE, the UE moving out of the current registration area, a universal integrated circuit card (UICC) containing a universal subscriber identity module (USIM) in the UE is removed, an entry of a “list of subscriber data” with a standalone non-public networks (SNPN) identity of a current SNPN is updated, and a rejected list is removed or deleted.

4. The method as claimed in claim 1, wherein the method comprises applying, by the UE, the NSSAI in the current registration area other than the subset of the current registration area.

5. The method as claimed in claim 1, wherein the reject cause is applied for the S-NSSAI received by the UE along with a registration reject message or a configuration update command message or in the NAS message for the subset of the current registration area.

6. The method as claimed in claim 1, wherein the subset of the current registration area comprises at least one of tracking area identity (TAI)-ID(s), cell ID(s), area identified by geographical co-ordinates, and closed access group (CAG) ID(s).

7. A method to apply rejected NSSAI area in a wireless network, comprising:
receiving, by a network apparatus in the wireless network, a registration request message for a candidate tracking area identity (TAI) from a plurality of TAIs from a user equipment (UE) in the wireless network; and
sending, by the network apparatus, a non-access stratum (NAS) message indicating a registration reject or a registration accept to the UE with a reject cause to the UE, wherein the reject cause indicates a single-network slice selection assistance information (S-NSSAI) is not available in a current registration area, and a subset of the current registration area where the reject cause is applied for the S-NSSAI, wherein the UE applies the NSSAI in the current registration area other than the subset of the current registration area.

8. The method as claimed in claim 7, wherein the reject cause is applied for the S-NSSAI is sent by the network apparatus along with the registration reject message or in the NAS message for the subset of the current registration area.

9. A UE to apply rejected NSSAI area in a wireless network, comprising:
a memory;
a processor; and
a rejected network slice selection assistance information (NSSAI) area controller, communicatively coupled to the memory and the processor, configured to:
send a registration request message with a requested NSSAI to a network apparatus in the wireless network;
receive a non-access stratum (NAS) message indicating at least one of:
registration accept or registration reject with a reject cause from the network apparatus, wherein the reject cause indicates a Single- NSSAI (S-NSSAI) is not available in a subset of a current registration area where the reject cause is applied for a S-NSSAI and a subset of a current registration area where the S-NSSAI is not allowed or allowed; and
perform at least one of:
store the rejected S-NSSAI in a rejected NSSAI for the subset of the current registration area,
delete a current stored registration area, consider the S-NSSAI is not available for the current tracking area; and
determine whether a S-NSSAI is allowed in the current area based on the stored information and triggering at least one of a registration procedure with requested NSSAI including the S-NSSAI or protocol data unit (PDU) session associated with S-NSSAI to receive services associated with S-NSSAI based on determination that S-NSSAI is allowed in the current area.

10. The UE as claimed in claim 9, wherein the rejected NSSAI area controller is configured to:
determine whether the S-NSSAI is allowed outside the current tracking area; and
trigger a registration procedure with the S-NSSIA as part of the requested NSSAI to receive services associated with the S-NSSAI based on the determination that the requested S-NSSAI is allowed outside the current tracking area.

11. The UE as claimed in claim 9, wherein the UE stores the S-NSSAI in the rejected NSSAI for the subset of the current registration area until at least one of switching off the UE, the UE moving out of the current registration area, a universal integrated circuit card (UICC) containing a universal subscriber identity module (USIM) in the UE is removed, an entry of a “list of subscriber data” with a standalone non-public networks (SNPN) identity of a current SNPN is updated, and a rejected list is removed or deleted.

12. The UE as claimed in claim 9, wherein the rejected NSSAI area controller is configured to apply the NSSAI in the current registration area other than the subset of the current registration area.

13. The UE as claimed in claim 9, wherein the reject cause is applied for the S-NSSAI received by the UE along with a registration reject message or a configuration update command message or in the NAS message for the subset of the current registration area.

14. The UE as claimed in claim 9, wherein the subset of the current registration area comprises at least one of tracking area identity (TAI)-ID(s), cell ID(s), area identified by geographical co-ordinates, and closed access group (CAG) ID(s).

15. A network apparatus to handle rejected network slice selection assistance information (NSSAI) area in a wireless network, comprising:
a memory;
a processor; and
a rejected NSSAI area controller, communicatively coupled to the memory and the processor, configured to:
receive a registration request message for a candidate tracking area identity (TAI) from a plurality of TAIs from a user equipment (UE) in the wireless network; and
send a non-access stratum (NAS) message indicating a registration reject or a registration accept to the UE with a reject cause to the UE, wherein the reject cause indicates a Single-NSSAI (S-NSSAI) is not available in a current registration area, and a subset of the current registration area where the reject cause is applied for the S-NSSAI, wherein the UE applies the NSSAI in the current registration area other than the subset of the current registration area.

16. The network apparatus as claimed in claim 15, wherein the reject cause is applied for the S-NSSAI is sent by the network apparatus along with the registration reject message or in the NAS message for the subset of the current registration area.
